(19) United States
(12) Patent Application Publication
(10) Pub. No.: US 2003/0069795 A1
(43) Pub. Date: Apr. 10, 2003

(54) Supplier data management system

(76) Inventors: Amy Hancock Boyd, Neenah, WI (US); Connie Lou Sauer, Neenah, WI (US); William Edward McCarty, Neenah, WI (US); Scott Jeffrey Park, Menasha, WI (US); James William Pontius, Neenah, WI (US); Thomas Keith Fisher, Neenah, WI (US); Michael John Bertello, Sherwood, WI (US); Jeffrey Dean Lindsay, Appleton, WI (US)

Correspondence Address: KIMBERLY-CLARK WORLDWIDE, INC., 401 NORTH LAKE STREET, NEENAH, WI, 54956

(21) Appl. No.: 10/253,200

(22) Filed: Sep. 23, 2002

Related U.S. Application Data
(60) Provisional application No. 60/326,128, filed on Sep. 28, 2001.

(51) Int. Cl. G06F 17/60; G06F 7/00

(52) U.S. Cl. 705/22; 707/104.1

(57) ABSTRACT

A data management system and method for raw material, the system including a network adapted to permit data transfer between a manufacturer and a supplier, wherein the manufacturer produces a product, and wherein the supplier supplies a raw material, the raw material having a raw material code and raw material property data; a database of raw material specifications in communication with the network, wherein the specifications are searchable by the raw material code; and a database of raw material property data connected to the network, wherein the database includes raw material property data from the supplier, and wherein the raw material property data are searchable by the raw material code. The system and method also include a data entry system connected to the network, wherein the data entry system is adapted to permit the supplier to transmit raw material property data to the manufacturer via the network; a generator connected to the network adapted to produce a comparison of the transmitted raw material property data with the corresponding raw material specification from the raw material specifications database; and a signal generator connected to the generator and adapted to receive the comparison and generate a compliance signal indicating whether the raw material is compliant with the corresponding raw material specification in response to the comparison.

### BACKGROUND

The present invention relates generally to a system for managing data between suppliers and manufacturers.

In the manufacturing of articles and goods by a product manufacturer, raw materials from one or more suppliers are typically received at the manufacturing facility and processed. For proper quality control, it is vital that incoming raw materials have properties corresponding to predetermined quality specifications given by the product manufacturer. It is further desirable that the raw materials are traceable during the manufacturing process, so that information about the origin and attributes of the raw materials can be linked to the products made from them. This allows the manufacturer to understand and resolve any quality problems that may arise during production.

Various regulations or standards require certification for products or materials. A certification can range in complexity from a standard certificate of conformance that simply states that the materials in a shipment meet a customer's specification, to a complete certificate of analysis (COA) that can include all or part of the data measured for the material or product, along with identifying batch numbers. Measurement techniques may also be included, along with other information as needed. For raw materials, a certificate of analysis is typically prepared by the supplier and sent to the product manufacturer prior to receipt of the shipment, though the certificate of analysis may be sent with the shipment as well. If the certificate of analysis or additional testing shows that the product is out of specification, the manufacturer may reject the shipment of raw materials or require other corrective action, often executed with a Corrective Action Request (CAR) asking the supplier to resolve the problem.

The role of regulations on manufacturing of products varies from industry to industry. In the medical industry, for example, many manufacturing processes are dictated by Good Manufacturing Practices (GMP), as specified in 40 C.F.R. §820. These regulations are being implemented in quality control systems for many industries, including the concepts of traceability of raw materials, efficient storage, and clean, easily-read packaging. Proper handling of certificates of analysis and their associated data is thus an area of significant industrial importance. Regardless of the nature of regulations, generating, storing, tracking, and validating certificates of analysis for raw materials is desirable to ensure the quality of products manufactured therefrom.

### SUMMARY

Present manual or computer-assisted methods of handling certificates of analysis and the associated data are subject to a variety of problems. For example, certificates of analysis may be sent by many means (e.g., fax, mail, e-mail) to product manufacturers, creating opportunities for loss or confusion, especially in the event there is not a common central destination that receives the certificates of analysis. This is a particular problem where more than one manufacturing facility of the product manufacturer receives the raw material, or where there are multiple parties at a manufacturing facility who may receive the certificates of analysis. In some cases, the manufacturer must request a certificate of analysis after receiving the shipment due to supplier error or to mishandling of the certificate of analysis on the part of the supplier, the product manufacturer, or a third party.

Shipment of raw material from a single source to multiple locations can create further difficulties when multiple certificates of analysis need to be prepared, increasing the likelihood of error. Matching the appropriate certificate of analysis to the product received can be difficult when multiple manufacturing facilities are involved. Data on the certificate of analysis may need to be manually entered and compared to specifications, with opportunities for human error. Various suppliers of a single raw material type may all use differing certificates of analysis, adding to the administrative burden on the product manufacturer who must decipher information provided in a plethora of potentially confusing formats.

Further, the complexities presented to quality control systems due to changes in material property specifications, especially during a transition phase between two similar but different specifications, can pose problems for present systems. This is especially true when a specification is upgraded to employ a modified or new test method; some raw material will still be received that was tested under the prior specification with the prior test method, leading to significant opportunities for confusion or delay with current systems.

The system and method described herein address the above-mentioned problems. The system and method described herein improve quality control and make the process of acquiring raw materials compliant with the needs of the product manufacturer. A computerized supplier data management system has been developed that enables suppliers of raw materials to provide information pertaining to the material properties and other aspects of the raw materials, and allows rapid verification of the incoming materials by the product manufacturer receiving the raw materials. The supplier data management system allows suppliers to provide material property information for rapid preparation of certificates of analysis in ways that correspond with requirements for Good Manufacturing Practices (GMP), including archiving information related to raw materials for use in subsequent quality audits, while greatly improving procedures for approving received raw materials for use.

More specifically, the system and method described herein include a network adapted to permit data transfer between a manufacturer and a supplier, wherein the manufacturer produces a product, and wherein the supplier supplies a raw material, the raw material having a raw material code and raw material property data; a database of raw material specifications in communication with the network, wherein the specifications are searchable by the raw material code; and a database of raw material property data connected to the network, wherein the database includes raw material property data from the supplier, and wherein the raw material property data are searchable by the raw material code. The system and method also include a data entry system connected to the network, wherein the data entry system is adapted to permit the supplier to transmit raw material property data to the manufacturer via the network; a generator connected to the network adapted to produce a comparison of the transmitted raw material property data with the corresponding raw material specification from the raw material specifications database; and a signal generator connected to the generator and adapted to receive the comparison and generate a compliance signal indicating whether the raw material is compliant with the corresponding raw material specification in response to the comparison.

The system and method described herein also include receiving a raw material specification from a manufacturer via an electronic network, wherein the raw material specification corresponds with the raw material code; selecting a raw material to meet the raw material specification, the raw material having raw material property data; entering the raw material property data into a supplier data management system provided by the manufacturer such that the raw material property data is associated with the raw material code; transmitting the raw material property data to the manufacturer via the network; generating a comparison of the raw material property data to the raw material specification using a generator within the supplier data management system; transmitting the comparison to the manufacturer via the network; and shipping the raw material to the manufacturer.

The system and method described herein also include defining a raw material specification for the raw material; storing the raw material specification in a database of raw material specifications in communication with an electronic network; transmitting the raw material specification to a supplier via the network; receiving the raw material property data from the supplier via the network; storing the raw material property data in a database of raw material property data in communication with the network; determining whether the raw material is in compliance with the raw material specification by comparing the raw material property data to the raw material specification using a data entry system; generating a compliance signal using a signal generator, wherein the compliance signal indicates whether the raw material is compliant with the corresponding raw material specification in response to the determining act; communicating the compliance signal to an operator; receiving a response to the compliance signal from the operator; and receiving the raw material from the manufacturer.

The supplier data management system offers several major advantages over prior systems. First, data entry and processing is made much more rapid, taking minutes to do what previously took hours. This is especially true if automatic entry of data from a data file is enabled. Another time-saver is the automatic determination of whether the batch is within specifications or not. Further, the creation of an electronic certificate of analysis for review by the product manufacturer, linked to the batch number or other identifier for the shipped material, eliminates mistakes, saves time, and improves the ability to audit manufacturing practices. The use of the supplier data management system as a decision-making tool can, in some embodiments, also help the supplier to reduce waste. Further still, the supplier data management system can offer the ability to properly handle raw materials tested under two or more specifications during a time of transition from one specification to another by providing two or more material codes or other input options for the same material type.

Other objects and advantages of the present invention will become more apparent to those skilled in the art in view of the following description and the accompanying drawings.

### DRAWINGS

The foregoing and other features, aspects, and advantages of the present invention will become better understood with regard to the following description, appended claims, and accompanying drawings where:

FIG. 1 schematically represents a process according to the present invention.

FIG. 2 schematically represents the interaction between several components of the process represented in FIG. 1.

FIG. 3 schematically represents one embodiment of hardware components of the process represented in FIG. 1.

### DETAILED DESCRIPTION OF THE PREFERRED EMBODIMENTS

As used herein, a “product” is any article, good, or composition that can be manufactured and sold. The manufacturer of the product is the “product manufacturer.” In one embodiment, products can include or, alternatively, can be limited to, any of the following or combination thereof: nonwoven webs or articles comprising nonwoven webs, consumer products, disposable products, personal care articles (e.g., incontinence products, tampons, sanitary napkins, diapers, disposable training pants such as HUGGIES PULL UPS-brand training pants, bandages, and the like), absorbent articles (e.g., diapers, sanitary napkins, tissue products, paper towels, tampons, and the like), disposable medical goods (e.g., sterile wrap, hospital gowns, disposable gloves, catheters, wound dressings, and the like), injection molded articles, automotive articles, durable goods, furniture, construction materials (e.g., dry wall, prefabricated beams, roofing materials, concrete mix, and the like), electronic components (e.g., computers, video recorders, stereo equipment, etc.), textiles, clothing, food, petrochemicals or other chemicals, and the like.

As used herein, a “raw material” is any material or combination of materials that can be used as a component in the manufacture of a product. A raw material for one process may be a product in another process. For example, rubber may be a raw material in the manufacture of radial tires, but radial tires may be considered a raw material in the manufacture of an automobile. In one embodiment, raw materials can be selected from those used in the manufacturer of absorbent articles. Such raw materials can include polymer films, nonwoven webs, woven webs, fibrous webs such as paper or airlaid webs, adhesives, fluff pulp, cellulosic fibers, elastic materials, superabsorbent particles, hook and loop materials, and the like. In another embodiment, raw materials can include those required for the manufacture of cellulosic webs such as tissue, paper towels, moist bath tissue, and wet wipes, including raw materials such as wood pulp, wet strength resins, creping adhesives, emollients, debonders, starch or starch derivatives, silicone compounds, and the like. Raw materials for food products can include specific fruits, vegetables, grains, meats, or extracts thereof, flavorings, spices, starches or other additives, preservatives, colorings, and the like.

As used herein, a “batch” of a raw material generally refers to a unit of raw material having a common origin, such as material from a mill that has been produced over a certain time period, typically over a 24-hour period or less, or during a period of time required to manufacture a fixed quantity of material in a batch process or continuous process. It can also refer to a raw material having a common geographical or commercial source as opposed to common production time, such as a quantity of ore taken from a given section of a mine, or a truck load of fruit provided by a single distributor. Generally an acceptable definition of batch for a manufacturing process can be selected from a range that will be determined by manufacturing parameters and other considerations by those skilled in the art. For many raw materials produced in factories under generally continuous and nominally steady-state conditions, a batch can be taken as the amount of goods produced in about 24 hours, absent other overriding considerations affecting the definition of a useful batch size. A shipment from a batch of raw material will generally include labels such as barcodes or other indicia giving an identification code for the batch, also known as the “batch ID” or “batch code,” or sometimes referred to as a “lot number.” In some cases, a batch may be taken as a grouping of multiple sub-units, each with their own identifying indicia.

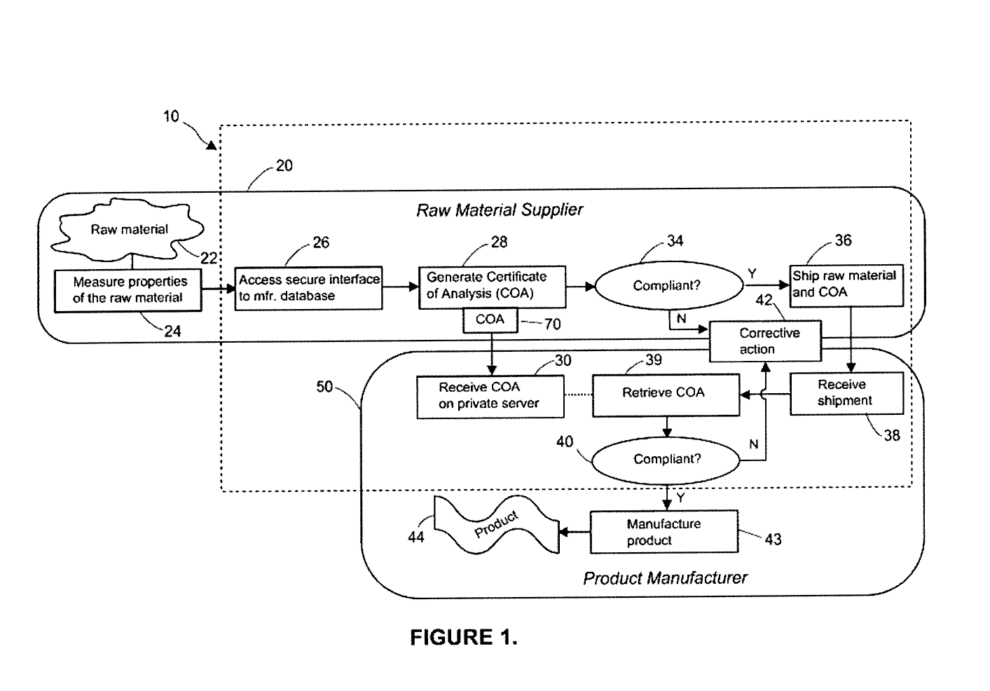

FIG. 1 is a flow chart illustrating some aspects of one embodiment of a supplier data management system 10, showing several steps in processing data for a batch of raw material 22 made by a raw material supplier 20 for a product manufacturer 50. The raw material supplier 20 measures properties 24 of the raw material 22, then accesses a secure interface 26 associated with a manufacturer database to enter data pertaining to the raw material 22. The data can be in electronic form, such as a spreadsheet or other data file, for automatic reading and uploading through the secure interface, or data can be manually entered. Data can be prepared by a laboratory or can come, at least in part, from online instrumentation, and can be generated with the help of a Laboratory Information Management System (LIMS) (not shown). Material property data can be also be produced by a combination of manual and automatic processes.

To accomplish this, the supplier data management system 10 includes a data entry system for a supplier to enter raw material properties and other information pertaining to a batch of a raw material 22 intended to be shipped to a product manufacturer. The data entry system allows the supplier to enter data into a computer system or via other electronic means, such as uploading a file onto a network. The data entry system can be a computer interface such as a Web-based interface in which a user from a supplier company who has an identifying ID and password or other secure access means can enter information. The user can select the raw material type to be shipped from a menu or from a plurality of displayed options in graphical or text form. The raw material type may include a raw material code, such as an alphanumeric string, or other identifiers linked to the specific intended use of the raw material 22. The data entry system in one embodiment permits the supplier to view only those raw material codes for which the supplier is qualified to supply to the product manufacturer.

Unlike prior manual methods of entering data in preparation of a certificate of analysis, it has been found that the data entry system can be used successfully in several complex situations if it provides the option to select from at least two versions of the raw material type when the user identifies the material in question. The availability of two versions is helpful in handling transitions from an old specification to a newer specification. New specifications may be needed to reflect changes in test methods or to reflect the addition or deletion of a reported parameter, or can reflect changes in the acceptable limits of a value computed in the analysis of the raw material property data. For example, a test method for a polyolefin product may take several days before the data are available. If an updated test method is instituted on a certain date, data may still come in afterwards that apply to the previous specification. Material of one raw material type, such as that intended for one particular use, being certified under the new specification could be identified and certified under one material code (e.g., PP-M3400-002) while material being certified under a prior specification during a transition period could be identified with a second material code (e.g., PP-M3400-001). In this way, the data entered for a material can be linked to the proper specification during a time of transition. In some cases, more than two versions of a material code may be desirable. Raw material 22 certified as acceptable under either code may be acceptable for the product manufacturer, but for proper documentation of quality, the differences in the test methods used to certify the raw material shipments should be recorded and archived, as can be automatically done under the present invention.

Alternatively, the data entry system could provide a single material code for the raw material 22, but with options to indicate which of two or more specifications are being used. For example, there could be a check box or other indication means to show that the data were being entered under a previous specification, or there could be an additional selection box to allow the user to pick the effective date of the specification to which the data applied (the default generally being the most recent specification). A display box showing the effective date of the applicable specification could also help the user determine if the correct data had been obtained, or if the correct test methods has been applied. In another example, a single material code may be modified by a second text field or by the manner in which the material code is displayed (e.g., red versus blue, or upper case versus lower case display) to indicate which version of two or more specifications applies to the raw material data.

The data entry system can communicate with a product manufacturer computer system, such as a private network, making the entered raw material property data available to the product manufacturer.

The preliminary work of determining the specifications needed for a particular raw material 22, qualifying one or more raw material suppliers 20, and requesting a predetermined quantity of the raw material 22 to be shipped are important steps. Typically, a purchasing department within the product manufacturer 50 will issue a purchase order for a quantity of raw material 22 from a selected raw material supplier 20. In addition to standard techniques used for established products and materials obtained from standard raw material suppliers, the process of identifying a raw material 22 to be purchased and/or a raw material supplier 20 to provide the raw material 22 can, in some circumstances, include the “fingerprint matching” method disclosed in WO 01/46883, “Method and System for Specifying Materials,” published Jun. 28, 2001 by A. Harthcock, which claims priority based on the U.S. patent application Ser. No. 09/467,319, filed Dec. 20, 1999. In this method, a variety of material properties desired by the product manufacturer are compared to a variety of measurements from the raw material supplier 20 to allow the product manufacturer 50 to determine if the fit is close enough for use in the manufacturing process 42. The ideal raw material 22 may not be well-specified or an ingredient may be sought that is not readily described. Thus, the product manufacturer may supply a series of chemical measurements with possible acceptable ranges to specify a potentially acceptable raw material 22, and the raw material supplier 20 may provide other measurements. The raw material supplier 20 may provide many more measurements than are called for in the stated specification or product request form, recognizing that the nature of a raw material 22 can include numerous attributes that may not have been expressly considered by the product manufacturer 50 but that may be helpful in judging the quality of the proposed raw material 22 and also its suitability for other products and processes that the product manufacturer may have developed or may be developing.

Several potential raw materials 22 from one or more raw material suppliers 20 can be evaluated and the one with a “fingerprint” best matching the desired material can be selected and automatically ordered. In this method, data can be exchanged between suppliers 20 and the product manufacturer 50 via a Web-based interface. The method of WO 01/46883 can be applied particularly when a non-standard material is needed, where a fixed, precisely defined product specification may not be applicable, and in other cases where the ideal properties of a needed raw material 22 are not well understood, or when a new product 44 is being developed for which the specifications may be somewhat tentative.

The software available to the raw material supplier 20 through the secure interface 26 allows a certificate of analysis generator 28 to generate a certificate of analysis 70. The generator 28 can electronically compare raw material property data with a corresponding raw material specification from the raw material specifications database (described below), and may also compute statistical properties such as means, standard deviation, maxima and minima, and other suitable statistical or process control parameters. The step of generating 28 the certificate of analysis 70 can include a mandatory requirement that the entered data be reviewed and verified by the person generating the certificate of analysis 70. For auditing purposes, an electronic signature can be obtained from the person entering the data to verify for the product manufacturer 50 that the data have been reviewed and are correct. One example of a system capable of generating electronic certificates of analysis is the Q-SYS system from Clyde Computing of England. Database for Quality (DBQ) software from Murphy Software of Southfield, Michigan can also be used to generate a certificate of analysis 70 or to compile the data from the raw material supplier 20 needed for generation of the certificate of analysis 70. The Process Pro Manufacturing software of EMR Innovations of St. Cloud, Minn. can also generate a printed certificate of analysis automatically with the packing list for a shipment.

The certificate of analysis 70 can be examined to determine if the raw material 22 is compliant 34 with product specifications. If the raw material 22 is not compliant 34, the raw material supplier 20 can take corrective action 42, seeking to resolve the problem. If the certificate of analysis 70 indicates that the raw material 22 is compliant, the raw material 22 can then be shipped 36 to the product manufacturer 50. An electronic notice of the shipment in progress can be sent to the product manufacturer 50 as part of the shipping step 36, and a printed copy of the certificate of analysis 70 can be attached with the shipment, along with identifying information for the batch (batch number, etc.). Bar codes or other machine-readable means may be used to convey some or all of the identifying information.

The product manufacturer 50 electronically receives 30 the certificate of analysis 70 using software or any other suitable method for comparison of raw material property data with product manufacturer raw material specifications. The certificate of analysis 70 can later be retrieved by any receiving station under control of the product manufacturer 50, provided the receiving station has access to the supplier data management system 10. Upon receiving the shipment 38, the product manufacturer 50 can retrieve 39 the electronic certificate of analysis 70 corresponding to the batch number of the raw material 22.

In one embodiment, the product manufacturer provides suppliers 20 with an electronic interface, such as a Web-based system, under the supplier data management system 10 adapted to provide a common format and appearance for each electronically-generated certificate of analysis. Thus, personnel who must use certificates of analysis (e.g., warehouse workers or employees at receiving docks) no longer must struggle with a myriad of differing and confusing forms that may be misplaced, and can readily access the certificate of analysis upon demand (e.g., by scanning a barcode from the shipment) and view it in a familiar format. Further, each certificate of analysis can have an easy-to-read acceptance indicator such as a bold “Y” or “N” in a predetermined location for “yes” or “no,” respectively, or a simple graphical indicator such as a picture of a green traffic light to indicate acceptance, or a red traffic light to indicate rejection for a raw material 22 not in compliance with specifications. Thus, training of personnel can be greatly simplified by a common form with simplified decision-indicating elements.

Standardized use of a single, electronically retrievable certificate of analysis form for multiple suppliers 20 of a raw material 22 greatly simplifies the process of receiving and accepting a raw material 22, and improves the ability to track the use of a raw material 22. Each raw material code may have differing features on the certificate of analysis, such as different test methods or material descriptors, but any material type can have substantially the same certificate of analysis format across multiple suppliers 20. It is not outside the scope of the present invention to customize the appearance of a certificate of analysis (e.g., color, graphical symbols, fonts, data table formats, etc.) for each supplier 20, if desired, or for each raw material type or class of raw materials, or for each intended final product.

In an alternate embodiment, a single certificate of analysis 70 can be available for multiple locations that receive shipments of the raw material 22 from a single batch of the raw material 22 described by the certificate of analysis 70. For example, portions of a batch of a raw material 22 may be shipped to multiple facilities belonging to the product manufacturer. Instead of needing to prepare separate certificates of analysis for each shipment, a single centralized certificate of analysis can be prepared in electronic form. The centralized COA can be electronically retrieved at each shipment location to ensure that the shipment has been properly received and is in compliance. Acceptance or rejection of the raw material 22 at the receiving facility and any manufacturing facility can be electronically stored and linked to quality control information for the product being manufactured to provide an audit trail. Any corrective action taken for rejected shipments can also be documented and the associated information stored.

Upon receiving a shipment 38, personnel at the receiving dock of the product manufacturer 50 can electronically access the certificate of analysis 70 or a subset of the information on the certificate of analysis 70, such as an indicator that the material is compliant or non-compliant. Personnel access the certificate of analysis 70 corresponding to the batch or lot number of the shipped raw material 22 and immediately determine if the shipment has been approved for use through the supplier data management system 10. Electronically accessing the certificate of analysis 70 or a subset of the information from the certificate of analysis 70 can occur by scanning a barcode on the raw material 22 shipment with a scanner, whereupon a signal is provided to indicate whether the raw material 22 can be accepted. The signal can be an electronic display of the entire certificate of analysis 70, such as a Web page display or other display on a computer monitor or the scanner itself, or can be a computer display of a message such as “accept” or “reject” with options to access additional information to determine appropriate corrective actions, or can be the flashing or activation of a light such as a red light to reject or a green light to accept, or can be an audible sound such as a voice stating that the raw material 22 should be accepted or rejected, and the like.

After determining whether the raw material 22 is compliant 40 with the specifications and other needs pertaining to the desired raw material 22 (e.g., proper quantity, shipped to the correct facility, timeliness, still in good condition, etc.), the raw material 22 can be accepted for manufacture 43 of the product 44. The decision to accept can be entered electronically to provide an archived record for both accounting and quality control purposes. If compliance is lacking, corrective action can be taken 42, including refusing the shipment, putting the shipment on hold, modifying the specifications, overriding the specifications temporarily, or renegotiating with the raw material supplier 20.

Corrective action 42 is illustrated as involving both the raw material supplier 20 and the product manufacturer 50. Corrective action 42 can include the use of Corrective Action Request (CAR) forms (not shown) to document problems and call for corrections from the raw material supplier 20. CAR forms can be completed and filed for any non-conformance to specifications, delivery problems, or any other supplier-related issue. After a CAR form has been issued, the supplier 20 can be alerted that a non-conformance has occurred and that adjustments must be made. The adjustments can include improving the supplier's process to eliminate the variation or, in some cases, by widening the specification if it cannot realistically be met on a regular basis. If no workable compromise can be reached, the product manufacturer 50 can look for a new supplier 20 or may revise the nature of the product 44.

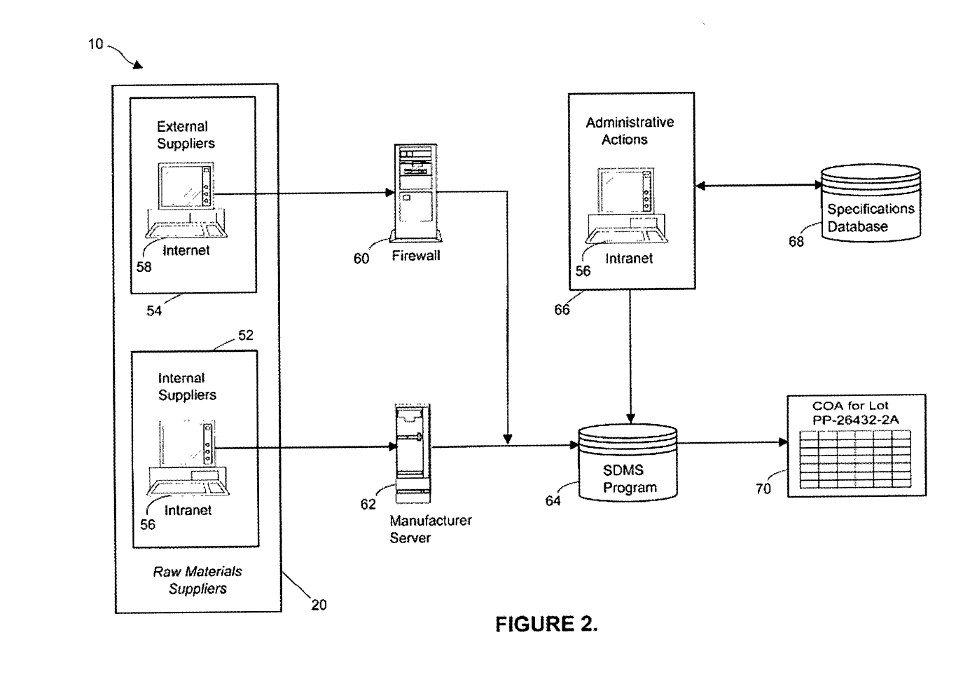

FIG. 2 illustrates another aspect of the supplier data management system 10, illustrating the relationship between several hardware components used in the exchange of data to create a certificate of analysis 70. Raw material suppliers 20 can include internal suppliers 52 as well as external suppliers 54.

Internal suppliers 52 can include entities within the same organization as the product manufacturer 50 or affiliated with the product manufacturer 50 such that they have access to a corporate Intranet 56 or other internal network of computers such as a LAN. Internal suppliers 52 can include makers of components needed in the manufacture of the product (not shown). For example, in the production of diapers or other absorbent articles, the product manufacturer 50 may own or control facilities that make components such as fluff pulp, films for use in an outer cover, adhesive compositions, tissue layers, nonwoven webs serving as an intake material or liner against the body, elastic components in cuffs and waist bands, hook and loop materials for fastening the article, odor control components, superabsorbent particles or fibers, and the like. Any of these components of the product 44 may be made internally by teams with access to a corporate Intranet 56.

External suppliers 54 can be any firm that makes a raw material 22 used in the manufacture of a product 44 by the product manufacturer 50, wherein the firm does not have access to private manufacturer servers 62 of the product manufacturer 50. The private manufacturer servers 62 are generally protected from external sources by a firewall 60. External suppliers 54 can provide data for use in the supplier data management system 10 over computers connected to the Internet 58 by accessing a secure Web site (not shown) of the product manufacturer 50 protected by a firewall 60. Access can be via a password-protected account.

Raw material specifications from a raw material specification database 68 for the product 44 are compared with the raw material data in this process, as directed by a central supplier data management system program. The raw material specification database 68 is connected to the network typically behind a product manufacturer firewall, wherein the specifications are searchable by raw material codes.

Data pertaining to the raw material properties is provided to the product manufacturer 50 via either a secure connection from the Internet 58 for an external supplier 54 or through an Intranet connection 56 to a private manufacturer server 62 for an internal supplier 52. The raw material property data are then processed by an application server 64, such as an Intranet server or an Internet server, which can generate Web pages, prepare a certificate of analysis 70 to be displayed on a Web-based browser or other electronic format, and so forth, in accordance with the supplier data management system 10 of the present invention. The application server 64 may be a plurality of servers or any other suitable hardware/software arrangement.

A raw material property database, which can be on the same server as the raw material specifications database 68 or on a separate private server, stores raw material property data received from a raw material supplier 20 and optionally stores additional material property data generated in testing by the product manufacturer. The raw material property data in the raw material property database are searchable by raw material codes.

The supplier data management system program on the applications server 64 can receive directions and special instructions, such as an override of a normal product specification, in the form of administrative actions 66 by an authorized party from the product manufacturer 50, typically via a computer connected to an Intranet 56. The supplier data management system program can then generate a certificate of analysis 70 for the batch of raw material 22 that can authorize use of the raw material 22 or indicate that the raw material 22 is out of specifications, in which case corrective action can be taken, as previously described.

Administrative actions 66 can also include modifying the list of approved raw material suppliers 20, updating supplier information, modifying the appearance or function of a Web-interface or other interface provided to raw material suppliers 20, modifying specifications, creating new raw material codes or modifying existing codes, deleting or modifying raw material information of certificates of analysis 70 when supplier information is incorrect, overriding default settings to reflect a negotiated modification in an agreement or a specification, providing further audit information and documentation, modifying accounts, and the like.

The certificate of analysis 70 can show the status of a batch of raw material 22 (e.g., accepted or rejected or on hold). The certificate of analysis 70 can be viewed by internal users of a raw material 22, including mill or factory personnel, and by the raw material supplier 20 or other authorized parties, and can be archived and stored in any suitable way. Additionally, the data required to generate a certificate of analysis 70 are stored, allowing the certificate of analysis 70 to be retrieved or regenerated upon demand by the product manufacturer 50. The certificate of analysis 70 can also include or be linked to archived information such as raw data, test methods used to obtain the data, information about who performed the testing and who entered the data, dates of preparation, information about modifications made in the date, details in the specifications applied, and so forth. Material Data Safety (MDS) information can also be combined with or associated with the certificate of analysis 70.

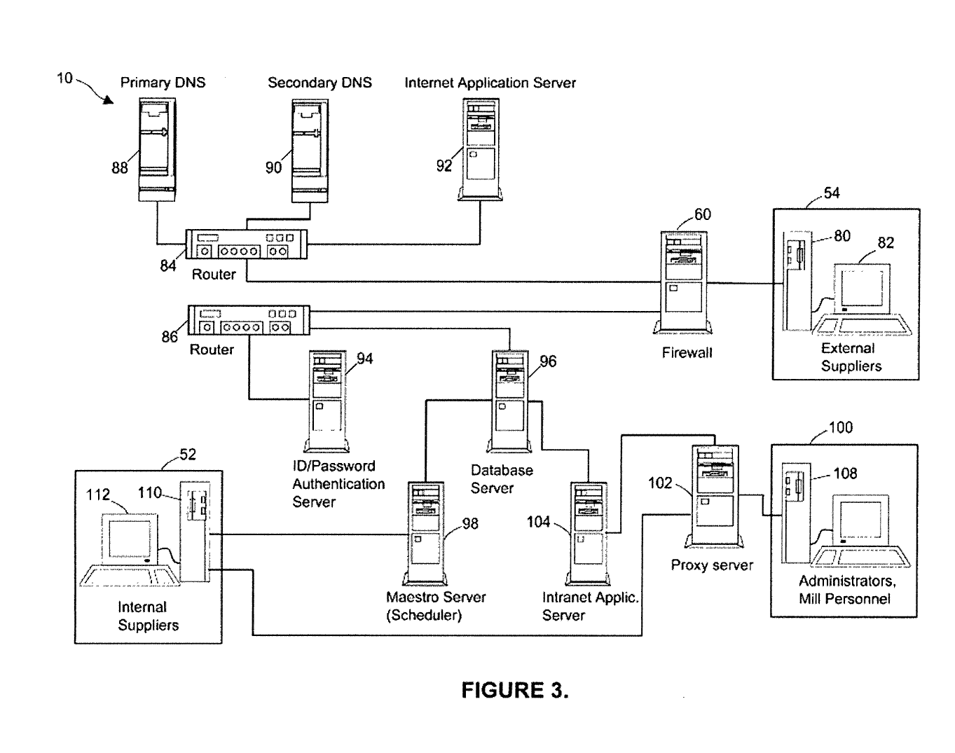

FIG. 3 illustrates one hardware arrangement of use in the present invention. Systems are shown for external suppliers 54, internal suppliers 52, and administrators 100. External suppliers 54 use their computer systems 80 to access the supplier data management system 10 through a firewall 60 under control of the product manufacturer 50. A user from an external supplier 54 enters a URL to access a secure Web site. The URL request goes through the firewall 60 to a first router 84, such as a CISCO-brand router, where either a primary domain name server (DNS) 88 or a secondary DNS 90 determines the IP address to be used for the requested URL. A signal is then sent to the Internet application server 92, which generates a signal to create a Web page display. The signal is routed back to the computer 80 of the external supplier user such that a Web page is displayed on a monitor 82. The displayed Web page requires the user to log in using a user ID and password. When the user ID and password are entered, that information is routed again through the firewall 60 to a second router 86 that directs the information to an ID/password authentication server 94 such as an SQL server. If a valid user ID and password have been entered, a welcome page for the supplier data management system 10 is then displayed. For example, a signal is sent to the Internet application server 92, which then sends a signal back to the computer 80 of the user to display the supplier data management system Web page. The welcome page displayed after logging in is unique to the external supplier 54 and provides access to additional pages that contain information unique to the external supplier 54, such that material codes for which the external supplier 54 has been qualified to supply can be displayed and selected. Information about material codes pertaining to the user is provided by the database server 96, such as a server with a WinSpex database, via the second router 86 to the Internet application server 92 to be added to the displayed Web pages in the secure supplier data management system Web environment for the external supplier 54.

In one embodiment, a Web-based supplier data management system can incorporate XQuery, an XML query language. An XQuery system, for example, could query a relational database such as a product specifications database and databases, as well as electronic data provided via Web pages or e-mail, incorporating data from several sources into a single XML document or Web page.

The user can select a material code for which a purchase request has been made and then enter data from a raw material batch to create a certificate of analysis 70. When the user has selected a raw material code from a Web page within the supplier data management system environment for the external supplier 54, a signal is routed through the firewall 60 to the second router 86 and then to the database server 96 to provide information about the specifications for the selected material code. A signal is then sent to the Internet application server 92, which in turn generates a Web page that allows entry of the required data either manually or, for example, by downloading an electronic file containing the material property data for the raw material 22 in question. After data have been entered, the supplier data management system program on the Internet application server 92 requires that the user verify that the data have been entered properly. In verifying the data, an electronic signature can be obtained, and the user ID, the electronic signature, and the time of verifying the data can all be stored on, for example, the database server 96 or other server, to provide an audit trail. Verified data submitted by the user is again routed to the database server 96 or another server, as desired, where it is stored. The supplier data management system program on the Internet application server 92 compares the entered data to the specifications from the database server 96 and generates an electronic certificate of analysis 70 that is displayed on the monitor 82 of the user of the external supplier 54. The certificate of analysis 70 displayed on the user's monitor 82 can indicate whether the raw material 22 is acceptable or not. The external supplier 54 can then ship the raw material 22 to one or more locations belonging to the product manufacturer 50.

The certificate of analysis 70 can be stored on the database server 96 or other servers, as desired, for future retrieval by the product manufacturer 50. The certificate of analysis 70 in electronic form can be stored, or the data used to generate the certificate of analysis 70 can be stored in a manner that allows the certificate of analysis 70 to be retrieved upon request, such that the certificate of analysis 70 is available upon demand due to the archiving of the requisite data.

FIG. 3 also pertains to internal suppliers 52, who can access the supplier data management system 10 via a corporate Intranet in much the same way the external supplier 54 does via an Internet connection. An internal user from an internal supplier 52 can enter a URL that is directed by a proxy server 102 to an Intranet application server 104 which provides a Web-based supplier data management system environment where the internal user can select the material code to be supplied and so forth. Specification data pertaining to the raw material 22 is provided by the database server 96. Web page display and generation of a certificate of analysis 70 is handled by the intranet application server 104. Alternatively, the internal user can download a file of raw material data to a Maestro server 98, where the file can then be scheduled to be processed automatically, with comparison of raw material data to the specifications on the database server 96, and automatic generation of a certificate of analysis 70. Information stored with the certificate of analysis 70 can include the time the data file was downloaded, the source of the file, and so forth, which can be part of an audit trail. The user can be asked to manually verify the accuracy of the data, if desired.

Access to the supplier data management system 10 by administrators or mill or factory personnel 100 is also shown. The computers 108 of the administrators or mill or factory personnel 100 access the Intranet application server 104 via a proxy server 102 to access Web pages that display specification information from the database server 96. Administrators or other suitable authorized personnel 100 may modify database contents such as updating specifications for a raw material 22 or adding or deleting material codes, or entering administrative information to document changes in specifications or user entries for purposes of future auditing. Mill or factory personnel can access the supplier data management system 10 to retrieve a certificate of analysis 70 and/or to trace quality information pertaining to a raw material 22 and its source, properties, shipment date, etc. An administrator 100 with access to the network can also modify or provide supplier access via password-protected accounts, provide additional documentation of actions taken for future auditing, and so forth. The product manufacturer can regularly update product manufacturer specifications that are accessed by the supplier 20.

The supplier data management system 10 also provides for a thorough audit trail. All entries and actions in the supplier data management system 10 can be traced, dated, archived, and audited to ensure compliance with GMP requirements. Data for a specific batch of material can be deleted by an administrator 100 if any portion of the data was entered in error. This permits the raw material supplier 20 to update the entered data, wherein archived documentation is provided by the administrator 100 concerning any corrections and the reasons for the corrections. Electronic signatures and time stamping may be used to authenticate dates and accountability.

Each entry that the user makes in the supplier data management system 10 can be recorded on a server. After the data for a batch of raw material 22 corresponding to a raw material code has been entered, the person must verify that the data are correct, and the submission of the data is then recorded and the data are processed to create a certificate of analysis linked to the batch ID of the raw material 22.

In one embodiment, for a user in a supplier company to use the supplier data management system 10, the user must first verify that they have been trained. For example, they can receive and read a manual, take a class, or use an interactive electronic training system to become trained, then contact an administrator 100 (typically an employee of the product manufacturer) to request access to the supplier data management system 10, which can entail receiving a user ID and password or other authorizing means to access the supplier data management system 10. The administrator 100 can ask several questions to verify that the person is trained, and also receives verification from the person's employer that the person should have access to the supplier data management system 10. The date of the person's call and other items are recorded as part of the audit trail, and the person is then given a password and user ID to access the supplier data management system interface. Alternatively, the above-mentioned actions of the administrator 100 can be automated with a computer program.

Further useful features of the supplier data management system 10 include a box on the submission form to enter comments about the batch, providing the option for editorial information not previously realized in manual certificate of analysis systems. If an error is detected after data has been submitted, the employee of the supplier 20 can contact an administrator 100 of the supplier data management system 10 and explain the problem. The administrator 100 can then delete erroneous information, entering an explanation to justify the change and allowing the raw material supplier 20 to enter corrected data. The change and related information can be recorded as part of the audit trail.

When a raw material 22 is received by the product manufacturer, the raw material 22 can be sampled and tested for material properties, including those reported by the supplier 20 on the certificate of analysis in order to validate the certificate of analysis. When a raw material 22 is shipped that falls outside the specifications of the product manufacturer, perhaps due to errors in measurement by the supplier 20, the product manufacturer may take corrective action, including returning the shipment or exploring other solutions such as means to compensate for the properties of the shipped raw material 22.

The supplier data management system 10 can be connected to or communicate with a number of other systems to increase the efficiency of a business. First, the supplier data management system 10 can be part of an integrated manufacturing system, such as the kind described in U.S. Pat. No. 5,311,438, “Integrated Manufacturing System,” issued May 10, 1994. Any known software can serve as the basis for the integrated manufacturing system, including products from WonderWare, Inc., Rockwell, Microsoft, and other vendors.

Second, the supplier data management system 10 can be incorporated into or linked with known software such as electronic data interchange (EDI) systems and SAP software. The supplier data management system 10 can also be integrated with quality control systems such as a distributed control system (DCS) and with computer-integrated manufacturing in general. The supplier data management system 10 can be integrated with SAP/R3 systems. For example, encapsulation of custom software, such as any supplier data management system component, can occur within SAP using SAP interface programs, called business application programming interfaces (BAPIs), which use Microsoft COM/DCOM connectors, allowing a Microsoft-based client to communicate with SAP R/3. Such connectors can be built using Microsoft ActiveX and COM/DCOM strategies. Known certificate of analysis generation tools can also be adapted, including the Proficy Certificate of Analysis Wizard, which is an ActiveX control.

Third, the supplier data management system 10 can be integrated with commercial quality control software, such as TRAQ-1 Quality Data Management System of the Gibson-Graves Company, Inc. This VAX-compatible software assists in the management of quality assurance information. This system is said to offer SPC (statistical process control) capability, as well as a range of data entry, analysis, graphics and reporting features. This system provides control for raw materials, process, and finished products. There are specific modules for tracking and reporting of defective materials and returned goods, certificates of analysis, and vendor analysis. This system also provides full database query and reporting capabilities. Graphical output includes control charts, histograms, Pareto charts, cusum charts, x-y correlations, etc. DBQ software can also be coupled with the supplier data management system 10.

Fourth, the supplier data management system 10 can be integrated with a system such as the Taratec e-Compliance™ Solution (TeC) system from Taratec of Bridgewater, N.J. This system enables data and file management to be controlled in a secure repository that supports the requirements of 21 CFR Part 11. This system allows security for all information to be maintained through Access Control Lists (ACLs), which provide the flexibility to grant access as required while protecting files against accidental modification or unauthorized access. The TeC system also allows users with appropriate permission to update individual files while maintaining copies of the original record and all subsequent versions. Secure audit trails capture information including date of modification, who modified the file, and why the file was changed. The TeC system is integratable into most existing computer systems and is non-invasive to data sources or applications. Systems supported include laboratory instrument data collection applications, data entry applications, and electronic batch records systems as well as Excel spreadsheets and Word files. Accessible through a Web browser, the TeC system stores all files, from raw data to Certificates of Analysis, in a secure, central location with a full audit trail. Building on the Oracle8i platform (Oracle Corporation), the TeC system provides the security and reliability of a Relational Database Management System (RDBMS) along with ease of use associated with standard file systems.

Fifth, the supplier data management system 10 can be integrated with vendor inventory management systems, in which a request for more material is automatically generated as stores of the material are depleted.

As an illustrative example of the system and method described herein, a polyethylene film may be identified with a code that is uniquely identified as a raw material 22 for a specific component of a specific product. The act of selecting a material type or, more precisely, a raw material code, with the data entry means can automatically link the data to be entered to the product manufacturer specifications for the material. The data can be entered manually or automatically from data files, networked instrumentation, or a LIMS, and the resulting means, standard deviations, maxima and minima, etc., or any required statistical parameters, can be automatically calculated for the multiple samples that may have been tested for each lot or batch. The product manufacturer may then cause a certificate of analysis or other summary form to be displayable for review by the raw material supplier 20, enabling the supplier 20 to determine if the batch is within specifications and determine which properties might pose problems. The certificate of analysis can be electronically stored on a private network of the product manufacturer to be electronically retrievable at one or more shipping destinations such as a manufacturing facility. The supplier 20 may choose to print the certificate of analysis for physical inclusion with the shipment, if desired.

The supplier data management system 10 offers several major advantages over prior systems. First, data entry and processing is made much more rapid, taking minutes to do what once took hours. This is especially true if automatic entry of data from a data file is enabled. Another time-saver is the automatic determination of whether the batch is within specifications or not. Further, the creation of an electronic certificate of analysis for review by the product manufacturer, linked to the batch number or other identifier for the shipped material, eliminates mistakes, saves time, and improves the ability to audit manufacturing practices. The use of the supplier data management system 10 as a decision-making tool can, in some embodiments, also help the supplier 20 to reduce waste. Further still, the supplier data management system 10 can offer the ability to properly handle a raw material 22 tested under two or more specifications during a time of transition from one specification to another by providing two or more material codes (or other input options) for the same material type.

As various changes could be made in the foregoing system without departing from the scope of the invention, it is intended that all matter contained in the above description and shown in the accompanying drawings shall be interpreted as illustrative and not in a limiting sense. Accordingly, this invention is intended to embrace all such alternatives, modifications and variations that fall within the spirit and scope of the appended claims.

We claim:

1. A data management system for raw material, the system comprising:
a network adapted to permit data transfer between a manufacturer and a supplier, wherein the manufacturer produces a product, and wherein the supplier supplies a raw material, the raw material having a raw material code and raw material property data;
a database of raw material specifications in communication with the network, wherein the specifications are searchable by the raw material code;
a database of raw material property data connected to the network, wherein the database includes raw material property data from the supplier, and wherein the raw material property data are searchable by the raw material code;
a data entry system connected to the network, wherein the data entry system is adapted to permit the supplier to transmit raw material property data to the manufacturer via the network;
a generator connected to the network adapted to produce a comparison of the transmitted raw material property data with the corresponding raw material specification from the raw material specifications database; and
a signal generator connected to the generator and adapted to receive the comparison and generate a compliance signal indicating whether the raw material is compliant with the corresponding raw material specification in response to the comparison.

2. The system of claim 1, wherein the data entry system is further adapted to permit the supplier to receive raw material specifications from the manufacturer via the network.

3. The system of claim 2, wherein the data entry system includes a Web page for receiving and transmitting.

4. The system of claim 1, further comprising identification verification in the connection of the data entry system to the network.

5. The system of claim 1, wherein the data entry system is adapted to receive manually-entered data.

6. The system of claim 1, wherein the data entry system is adapted to receive electronically-entered data.

7. The system of claim 1, wherein the data entry system is adapted to verify the training of an operator before allowing the operator to access the data entry system.

8. The system of claim 1, wherein the data entry system includes means for selecting a material property code from a display of at least two material property codes.

9. The system of claim 1, wherein the data entry system is connected to the signal generator and is adapted to communicate the compliance signal to a user.

10. The system of claim 1, wherein the data entry system is further adapted to receive from the user a response to the compliance signal.

11. The system of claim 1, wherein the signal generator and the data entry system are the same component.

12. The system of claim 1, wherein the data entry system includes a scanner.

13. The system of claim 1, wherein the database of raw material specifications is adapted to accommodate amendments to raw material specifications.

14. The system of claim 1, wherein the manufacturer and the supplier are the same entity.

15. The system of claim 1, wherein the generator is adapted to generate a certificate of analysis.

16. The system of claim 15, wherein the certificate of analysis includes a display of the comparison.

17. The system of claim 15, wherein the manufacturer has a plurality of facilities, and wherein each facility is adapted to receive the certificate of analysis.

18. The system of claim 1, wherein the generator is adapted to calculate statistical data from the raw material property data.

19. The system of claim 1, wherein the network includes the Internet.

20. The system of claim 1, wherein the network includes an intranet.

21. The system of claim 1, further comprising a connection between the system and an integrated manufacturing system.

22. The system of claim 1, further comprising a connection between the system and an electronic data interchange system.

23. The system of claim 1, further comprising a connection between the system and a quality control software system.

24. The system of claim 1, further comprising a connection between the system and an access security system.

25. The system of claim 1, further comprising a connection between the system and a vendor inventory management system.

26. The system of claim 1, further comprising error correction means for correcting and documenting errors in raw material data.

27. The system of claim 1, further comprising time stamping means for documenting actions taken with respect to the system.

28. A method for supplying a compliant raw material identified by a raw material code, the method comprising:
receiving a raw material specification from a manufacturer via an electronic network, wherein the raw material specification corresponds with the raw material code;
selecting a raw material to meet the raw material specification, the raw material having raw material property data;
entering the raw material property data into a supplier data management system provided by the manufacturer such that the raw material property data is associated with the raw material code;
transmitting the raw material property data to the manufacturer via the network;
generating a comparison of the raw material property data to the raw material specification using a generator within the supplier data management system;
transmitting the comparison to the manufacturer via the network; and
shipping the raw material to the manufacturer.

29. The method of claim 28, further comprising displaying the raw material specification using a data entry system.

30. The method of claim 29, wherein the displaying act includes using a Web page.

31. The method of claim 29, further comprising verifying the training of an operator before allowing the operator to access the data entry system.

32. The method of claim 28, further comprising verifying supplier identification prior to the receiving and entering acts.

33. The method of claim 28, wherein the entering act is performed manually.

34. The method of claim 28, wherein the entering act is performed electronically.

35. The method of claim 28, further comprising selecting a material property code from a display of at least two material property codes.

36. The method of claim 28, wherein the generating act further includes generating a certificate of analysis, wherein the certificate of analysis indicates whether the raw material is compliant with the raw material specification.

37. The method of claim 36, wherein the certificate of analysis includes a display of the comparison.

38. The method of claim 36, wherein the manufacturer has a plurality of facilities, and wherein the transmitting act includes transmitting the certificate of analysis to each facility.

39. The method of claim 28, further comprising calculating statistical data from the raw material property data.

40. The method of claim 28, wherein the network includes the Internet.

41. The method of claim 28, wherein the network includes an intranet.

42. The method of claim 28, further comprising correcting and documenting errors in raw material data.

43. The method of claim 28, further comprising time stamping and documenting actions taken with respect to the system.

44. The method of claim 28, further comprising generating an electronic certificate of analysis summarizing the raw material property data and indicating the comparison.

45. The method of claim 28, further comprising providing a password-protected Web-based interface such that the supplier can display the raw material specifications.

46. A method for a manufacturer to obtain a compliant raw material having raw material property data, the method comprising:
defining a raw material specification for the raw material;
storing the raw material specification in a database of raw material specifications in communication with an electronic network;
transmitting the raw material specification to a supplier via the network;
receiving the raw material property data from the supplier via the network;
storing the raw material property data in a database of raw material property data in communication with the network;
determining whether the raw material is in compliance with the raw material specification by comparing the raw material property data to the raw material specification using a data entry system;
generating a compliance signal using a signal generator, wherein the compliance signal indicates whether the raw material is compliant with the corresponding raw material specification in response to the determining act;
communicating the compliance signal to an operator;
receiving a response to the compliance signal from the operator; and
receiving the raw material from the manufacturer.

47. The method of claim 46, further comprising verifying manufacturer identification prior to the transmitting act.

48. The method of claim 46, further comprising verifying the training of an operator before allowing the operator to access the manufacturer data entry system.

49. The method of claim 46, further comprising selecting a material property code from a display of at least two material property codes.

50. The method of claim 46, further comprising accommodating amendments to raw material specifications within the database of raw material specifications.

51. The method of claim 46, further comprising communicating the compliance signal to a user.

52. The method of claim 51, further comprising receiving from the user a response to the compliance signal.

53. The method of claim 46, further comprising generating a certificate of analysis, wherein the certificate of analysis indicates whether the raw material is compliant with the raw material specification.

54. The method of claim 53, wherein the certificate of analysis includes a display of the result of the determining act.

55. The method of claim 53, wherein the manufacturer has a plurality of facilities, and further comprising receiving the certificate of analysis at each facility.

56. The method of claim 46, further comprising calculating statistical data from the raw material property data.

57. The method of claim 46, further comprising facilitating communication between the system and an integrated manufacturing system.

58. The method of claim 46, further comprising facilitating communication between the system and an electronic data interchange system.

59. The method of claim 46, further comprising facilitating communication between the system and a quality control software system.

60. The method of claim 46, further comprising facilitating communication between the system and an access security system.

61. The method of claim 46, further comprising facilitating communication between the system and a vendor inventory management system.

62. The method of claim 46, further comprising correcting and documenting errors in raw material data.

63. The method of claim 46, further comprising time stamping and documenting actions taken with respect to the system.

64. The method of claim 46, further comprising choosing between receiving a shipment of raw material if the raw material is compliant, and taking corrective action if the raw material is not compliant.
